(19) United States
(12) Patent Application Publication
(10) Pub. No.: US 2018/0036869 A1
(43) Pub. Date: Feb. 8, 2018

(54) HIGH TORQUE RATCHET WRENCH

(71) Applicants: CHIEN-CHUAN KAO, Taichung City (TW); CHAO-CHIH LIU, Taichung City (TW)

(72) Inventors: CHIEN-CHUAN KAO, Taichung City (TW); CHAO-CHIH LIU, Taichung City (TW)

(21) Appl. No.: 15/226,125

(22) Filed: Aug. 2, 2016

(51) Int. Cl. B25B 13/46; B25B 23/00

(52) U.S. Cl. CPC B25B 13/463; B25B 23/0007

(57) ABSTRACT

A high torque ratchet wrench includes a main body having a handle and a head, the head having a first, second, and third cavities; a ratchet wheel rotatably disposed in the first cavity and having plural teeth; a direction switching assembly movably disposed in the second cavity; a ratchet block movably disposed in the third cavity and between the ratchet wheel and the direction switching assembly; and two torque blocks disposed in the third cavity and facing the ratchet block. The ratchet block has two sides provided with a first and a second held surfaces. The direction switching assembly moves between a first and second positions to force the ratchet block to engage the ratchet wheel. When the direction switching assembly is at the first or second position, the first held surface or the second held surface is correspondingly pushed by one of the torque blocks.

### BACKGROUND OF THE INVENTION

### 1. Field of the Invention

The present invention relates to wrench tools, and more particularly, to a high torque wrench.

### 2. Description of the Related Art

As shown by FIG. 1, a traditional ratchet wrench comprises a wrench body 1, a ratchet wheel 3, a direction switching member 5, and a ratchet block 6. The wrench body 1 includes a head 2 and a handle. The head 2 is provided with a first cavity 2a, a second cavity 2b, and a third cavity 2c between the first cavity 2a and the second cavity 2b. The center of the third cavity 2c is included in the first cavity 2a. The ratchet wheel 3 is disposed in the first cavity 2a and peripherally provided with plural teeth 4. The direction switching member 5 is pivotally disposed in the second cavity 2b. The ratchet block 6 is disposed in the third cavity 2c and between the ratchet wheel 3 and the direction switching member 5, so as to be engaged with the teeth 4. When the direction switching member 5 is optionally moved between a first position and a second position, the ratchet block 6 is correspondingly engaged with the teeth 4.

Recently, the requirement toward the torque provided by a ratchet wrench is higher for stably outputting a higher torque value. However, during the manufacturing process of the ratchet wrench, different components are usually supplied by different factories; also, manufacturing accuracy of the same component model made by each factory are not identical. Therefore, when assembling the components, an inaccuracy often occurs between the held face of the ratchet block 6 and the inner wall of the third cavity 2c, such that a gap exists between the teeth 4 and the ratchet block 6. As a result, the teeth 4 and the ratchet block 6 are prevented from being completely matched with each other, producing an instable torque output.

If a stable high torque output is required, the inaccuracy tolerance of each component against other components shall be accurately calculated, so as to maintain a tight adherence between the held surface of the ratchet block 6 and the inner wall of the third cavity 2c, whereby there is substantially no gaps existing between the teeth 4 and the ratchet block 6, and a stable high torque output is achieved.

However, in order to increase the manufacturing accuracy of each component, not only the cost is higher, but also the different accuracy standards provided by different factories shall be considered. Therefore, unless an integrated production line is applied, a ratchet wrench with stable high torque output is difficult to be achieved.

Thus, the issue of stably outputting a high torque without increasing the present assembling method and process needs to be resolved.

### SUMMARY OF THE INVENTION

For improving the aforementioned issues, embodiments of the present invention disclose a high torque ratchet wrench. By use of two torque blocks disposed on two sides of the ratchet block, when the ratchet block is engaged with the ratchet wheel, a lateral side of the ratchet block is pushed by the torque block. With one side of the torque block is formed in an arc shape, a biasing effect thereof is provided, such that the torque block biasedly moves to an appropriate position along the rotation of the ratchet wheel, whereby the a surface of the ratchet block remains being pushed by the torque block. Therefore, the gap between the relative components due to manufacturing inaccuracy is eliminated. The structural tightness is enhanced, and the high torque output is stably provided.

For achieving the aforementioned objectives, embodiments of the present invention provide a high torque ratchet wrench, comprising:

a main body including a handle and a head, the head provided with a first cavity, a second cavity connected with one side of the first cavity, and a third cavity disposed between and connected with the first cavity and the second cavity;

a ratchet wheel rotatably disposed in the first cavity and peripherally provided with plural teeth;

a direction switching assembly movably disposed in the second cavity;

a ratchet block movably disposed in the third cavity and between the ratchet wheel and the direction switching assembly, the ratchet block having two opposite sides thereof provided with a first held surface and a second held surface, wherein the direction switching assembly optionally moves between a first position and a second position, such that the direction switching assembly forces the ratchet block to engage the ratchet wheel; and

two torque blocks disposed in the third cavity and facing the ratchet block, wherein when the direction switching assembly is at the first position or the second position, the first held surface or the second held surface of the ratchet block is correspondingly pushed by one of the torque blocks.

With such configuration, the objective of the present invention is that by use of the torque blocks pushing the ratchet block, a tooth portion of the ratchet block is engaged with the teeth without gaps therebetween, so as to enhance the tightness of the engagement between the ratchet block and the ratchet wheel. As a result, during the rotation operation of the present invention, a high torque is stably output. Therefore, the engagement between the components is improved and the high torque output is achieved without increasing the manufacturing accuracy of different components and the cost and time of doing so or varying the overall producing process. Also, the structural strength of the ratchet wrench provided by the present invention is higher than the traditional ratchet wrench, so that the service life of the ratchet wrench provided by the present invention is enhanced.

### BRIEF DESCRIPTION OF THE DRAWINGS

FIG. 1 is a partially sectional view of a known ratchet wrench.

FIG. 2 is a perspective view of a ratchet wrench in accordance with an embodiment of the present invention.

FIG. 3 is an exploded view of the ratchet wrench in accordance with an embodiment of the present invention.

FIG. 4 is a partial schematic view of an embodiment of the present invention, illustrating the first held surface pushed by the torque block.

FIG. 5 is another partial schematic view of an embodiment of the present invention, illustrating the second held surface pushed by the torque block.

FIG. 6A is another partial schematic view of an embodiment of the present invention, illustrating the torque block biasedly moved.

FIG. 6B is another partial schematic view of an embodiment of the present invention, illustrating the torque block biasedly moved to an appropriate position.

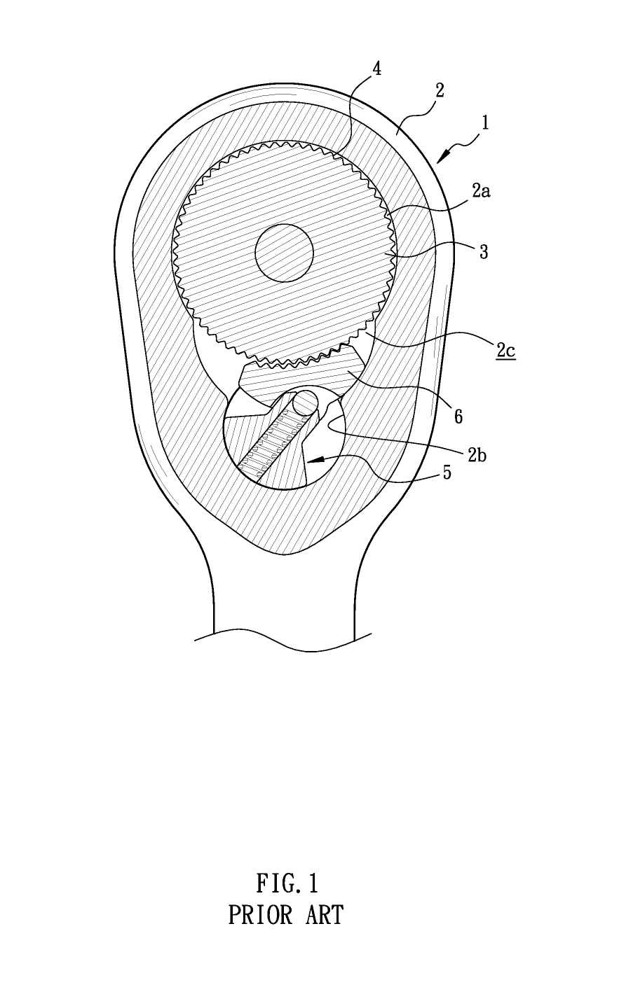

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

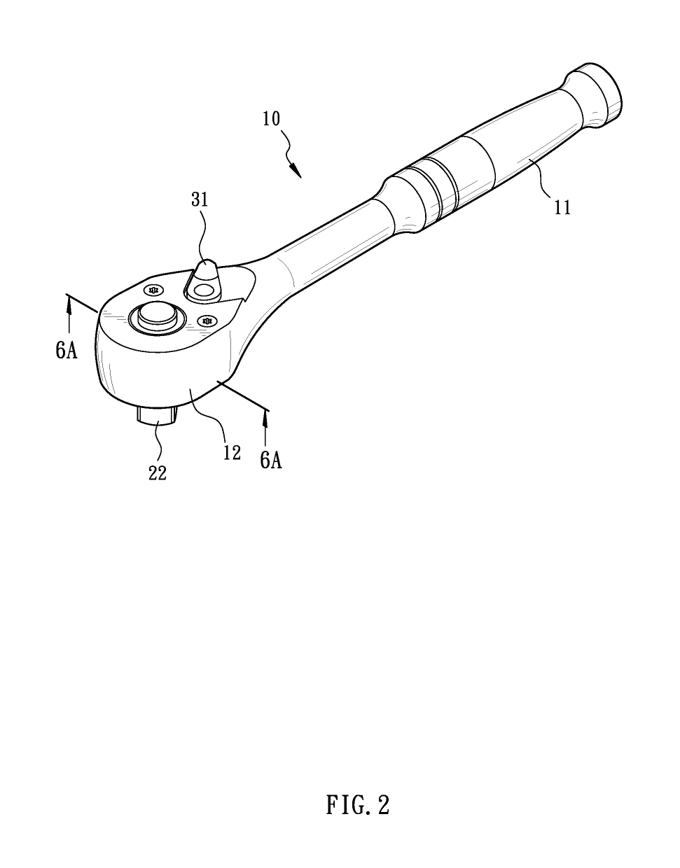

Referring to FIG. 2 to FIG. 6B, a ratchet wrench of an embodiment of the present invention comprises a main body 10, a ratchet wheel 20, a direction switching assembly 30, a ratchet block 40, two torque blocks 50, a resilient member 60, and a cover 70.

The main body 10 includes a handle 11 and a head 12. The head 12 is provided with a first cavity 121, a second cavity 122, and a third cavity 123 passing therethrough. One side of the first cavity 121 is connected with the second cavity 122. The third cavity 123 is disposed between and connected with the first cavity 121 and the second cavity 122. The center of the third cavity 123 is included in the first cavity 121. Two sides of the third cavity 123 are disposed with a groove 124, respectively.

The ratchet wheel 20 is rotatably disposed in the first cavity 121 and peripherally provided with plural teeth 21. The ratchet wheel 20 includes a driving portion 22, wherein the central axis of the driving portion 22 is arranged in axial alignment with the center of the first cavity 121.

The direction switching assembly 30 is movably disposed in the second cavity 122 and movable between a first position and a second position. The direction switching assembly 30 includes a direction switching member 31 and a pushing member 32. The direction switching member 31 is transversely provided with a housing 311, and the pushing member 32 is received in the housing 311. The user turns the direction switching member 31 to switch the direction. Furthermore, the pushing member 32 includes a spring 321 and a pushing plate 322. The spring 321 resists against a part between the pushing plate 322 and the housing 311. In an embodiment of the present invention, the pushing plate 322 is formed in an E shape. The pushing plate 322 is provided with a transverse rod 323, and the spring 321 is mounted around the transverse rod 323.

The ratchet block 40 is movably disposed in the third cavity 123 and placed between the ratchet wheel 20 and the direction switching assembly 30. Two opposite sides of the ratchet block 40 are provided with a first held surface 41 and a second held surface 42. A front side of the ratchet block 40 is provided with a tooth portion 43; a rear side of the ratchet block 40 is provided with a resisting face 44. The first held surface 41 and the second held surface 42 respectively face two grooves 124. The tooth portion 43 is allowed to be engaged with the teeth 21, and the resisting face 44 is pushed by the pushing plate 322.

When the direction switching assembly 30 optionally moves between the first position and the second position, the tooth portion 43 of the ratchet block 40 is engaged with the teeth 21, such that the ratchet wheel 20 rotates in clockwise or counterclockwise direction, whereby the user fastens or loosens a screw or bolt.

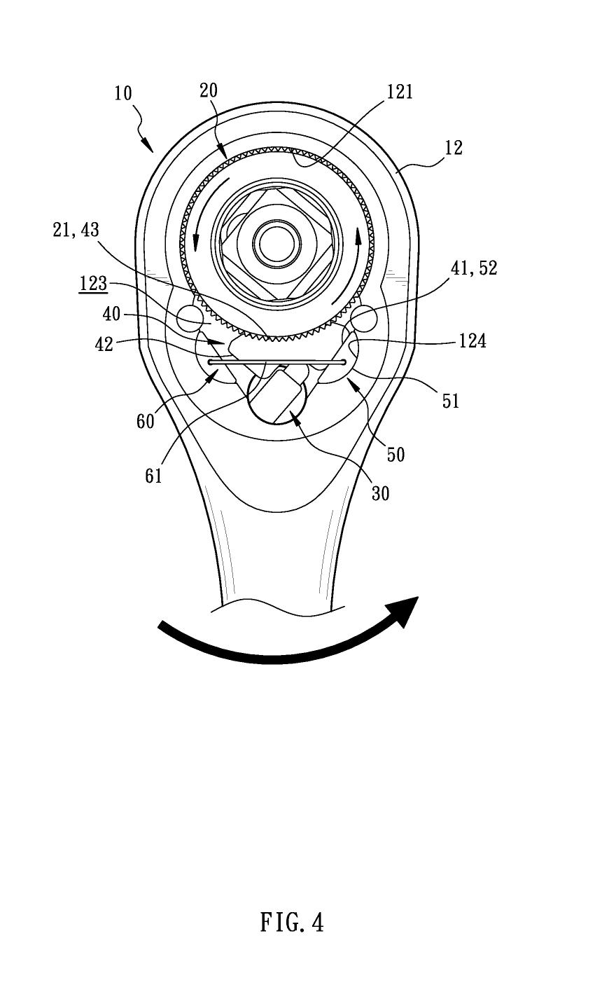

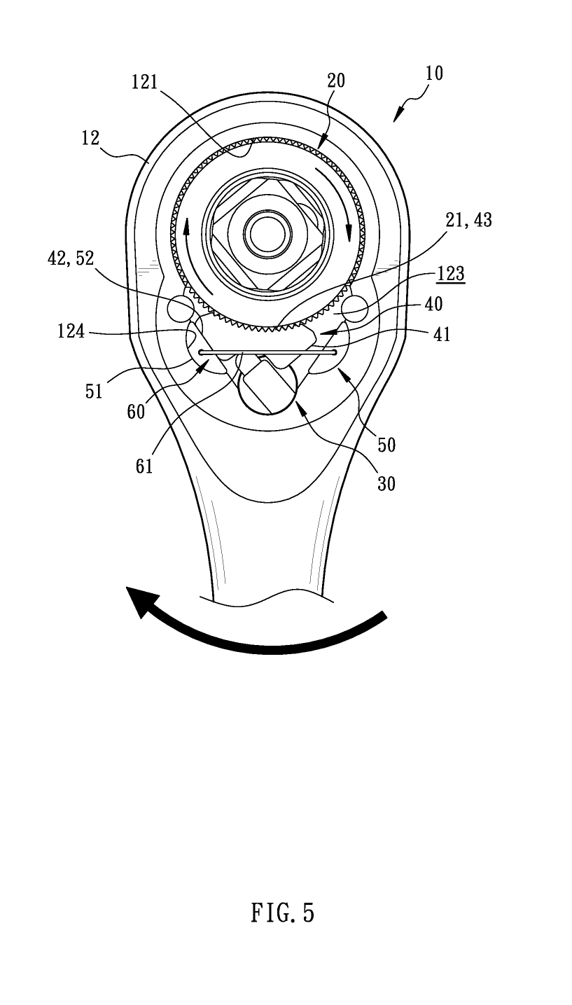

The two torque blocks 50 are movably disposed in the two grooves 124, respectively. Two opposite sides of each torque block 50 are provided with a received side 51 and a resisting side 52. Also, the top surface of each torque block 50 is provided with a combining bore 53. The received side 51 is matched with and attached to the inner wall of the corresponding groove 124. The resisting side 52 protrudes from or flushes with two sides of the groove 124. As shown by FIG. 4, when the direction switching assembly 30 is at the first position, the first held surface 41 is pushed by the resisting side 52 of the torque block 50 on the right side of FIG. 4; when the direction switching assembly 30 is at the second position, the second held surface 42 is pushed by the resisting side 52 of the torque block 50 on the left side of FIG. 5.

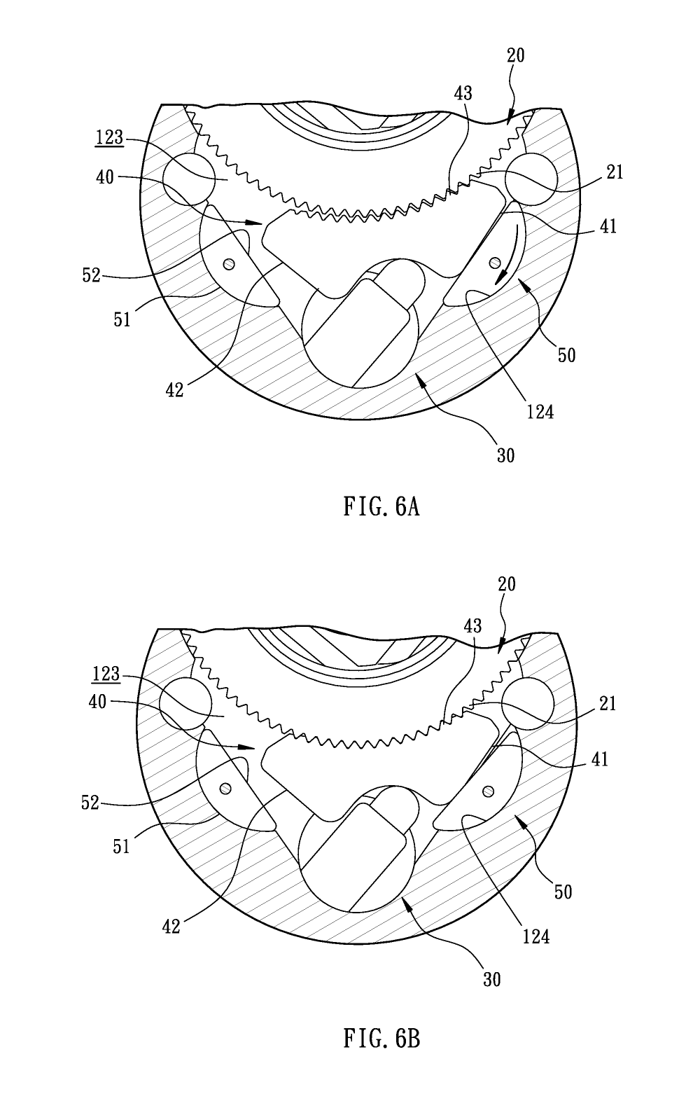

In addition, in an embodiment of the present invention, the first held surface 41 and the second held surface 42 are flat-shaped, while the received side 51 is arc-shaped and the resisting side 52 is flat-shaped. When the resisting side 52 of one of the torque blocks 50 pushes the first held surface 41 or the second held surface 42, the arc-shaped received side 51 provides a biasing effect upon the torque block 50, such that the torque block 50 biasedly move to an appropriate position along the rotation of the ratchet wheel 20, whereby one of the first held surface 41 and the second held surface 42 remains being pushed by the corresponding resisting side 52, as shown by FIG. 6A and FIG. 6B. Therefore, the gaps between relative components due to inaccurate manufacturing process are eliminated, and the structural tightness is enhanced.

In an embodiment of the present invention, the resilient member 60 is formed in a reversed U shape. The resilient member 60 includes a connecting shaft 61 and two feet 62. The two feet 62 are fixed in the two combining bores 53. The resilient member 60 connects the two torque blocks 50 through the connecting shaft 61 and limits the torque blocks 50 in the two grooves 124, so as to prevent the two torque blocks 50 from being detached from the two grooves 124. Also, in the embodiment of the present invention, the resilient member 60 is disposed at a height which is higher than the height at which the ratchet block 40 is disposed in the third cavity 123, such that the resilient member 60 does not interfere with the ratchet block 40 when the direction switching assembly 30 optionally moves between the first position and the second position.

A cover 70 is fastened at the head 12 and covers the first cavity 121, the second cavity 122, and the third cavity 123. The cover 70 includes a through hole 71, through where the driving portion 22 protrudes. Also, an O-ring 80 is mounted between the driving portion 22 and the cover 70 for preventing the cover 70 from being detached from the driving portion 22.

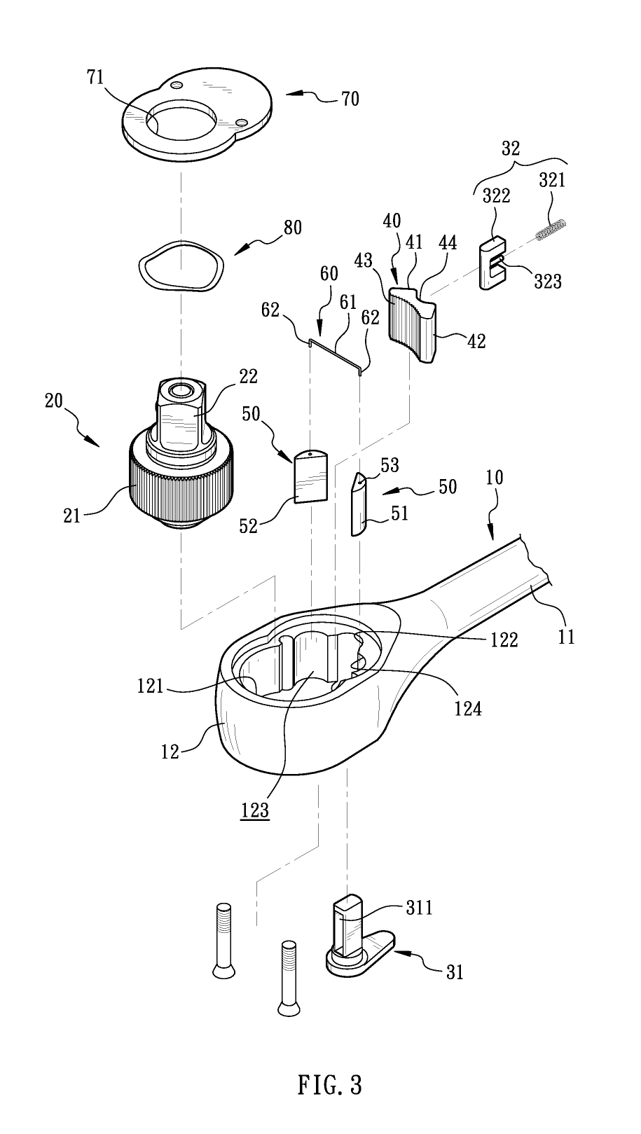

Referring to FIG. 3 to FIG. 4, FIG. 6A, and FIG. 6B, the direction switching member 31 is at the first position. When the user turns the direction switching member 31 to the position on the right side of the drawings, the tooth portion 43 is engaged with the teeth 21, and the user is able to grasp the handle 11, thereby driving the ratchet wheel 20 in counterclockwise direction to fasten or loosen a screw or bolt. In addition, the torque block 50 on the right side of the drawings is biasedly moved to an appropriate position along the rotation of the ratchet wheel 20, such that the first held surface 41 maintains being pushed by the corresponding resisting side 52. Therefore, gaps between relative components due to manufacturing inaccuracy are eliminated, so that the tooth portion 43 is completely engaged with the teeth 21 without gaps, thus increasing the tightness between the ratchet block 40 and the ratchet wheel 20 and stabilizing the high torque output.

Referring to FIG. 2, FIG. 5, FIG. 6A, and FIG. 6B, the direction switching member 31 is at the second position. When the user turns the direction switching member 31 to the position on the left side of the drawings, the tooth portion 43 is engaged with the teeth 21, and the user is able to grasp the handle 11, thereby driving the ratchet wheel 20 in clockwise direction to fasten or loosen a screw or bolt. In addition, the torque block 50 on the left side of the drawings is biasedly move to an appropriate position along the rotation of the ratchet wheel 20, such that the second held surface 42 maintains being pushed by the corresponding resisting side 52. Therefore, gaps between relative components due to manufacturing inaccuracy are eliminated, so that the tooth portion 43 is completely engaged with the teeth 21 without gaps, thus increasing the tightness between the ratchet block 40 and the ratchet wheel 20 and stabilizing the high torque output.

To sum up, the high torque ratchet wrench provided by the embodiment of the present invention, by use of the torque blocks 50 biasedly moved to the appropriate position along the rotation of the ratchet wheel 20, the first held surface 41 or the second held surface 42 remains being pushed by the corresponding resisting side 52, such that gaps between relative components due to manufacturing inaccuracy are eliminated. As a result, the tooth portion 43 is completely engaged with the teeth 21, thus increasing the tightness between the ratchet block 40 and the ratchet wheel 20, thereby providing a stable high torque output. Therefore, the stable high torque output is achieved without increasing the manufacturing accuracy of different components and the cost and time of doing so or varying the overall producing process. Also, the structural strength of the ratchet wrench provided by the present invention is higher than the traditional ratchet wrench, so that the service life of the ratchet wrench provided by the present invention is enhanced.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A high torque ratchet wrench, comprising:
a main body including a handle and a head, the head provided with a first cavity, a second cavity connected with one side of the first cavity, and a third cavity disposed between and connected with the first cavity and the second cavity;
a ratchet wheel rotatably disposed in the first cavity and peripherally provided with plural teeth;
a direction switching assembly movably disposed in the second cavity;
a ratchet block movably disposed in the third cavity and between the ratchet wheel and the direction switching assembly, the ratchet block having two opposite sides thereof provided with a first held surface and a second held surface, wherein the direction switching assembly optionally moves between a first position and a second position, such that the direction switching assembly forces the ratchet block to engage the ratchet wheel; and
two torque blocks disposed in the third cavity and facing the ratchet block, wherein when the direction switching assembly is at the first position or the second position, the first held surface or the second held surface of the ratchet block is correspondingly pushed by one of the torque blocks.

2. The ratchet wrench of claim 1, wherein center of the third cavity is included in the first cavity, and two sides of the third cavity are disposed with a groove, respectively.

3. The ratchet wrench of claim 2, wherein two opposite sides of each torque block are provided with a received side and a resisting side; the received side is matched with and attached to an inner wall of the corresponding groove; the resisting side of one of the torque block pushes the corresponding first held surface or the second held surface.

4. The ratchet wrench of claim 3, wherein the resisting side protrudes from or flushes with two sides of the corresponding groove.

5. The ratchet wrench of claim 3, wherein the received sides are formed in a shape matched with a shape of the grooves.

6. The ratchet wrench of claim 3, wherein the received side is arc-shaped.

7. The ratchet wrench of claim 3, wherein the resisting side is flat-shaped.

8. The ratchet wrench of claim 1, further comprising a resilient member having two ends thereof respectively fixed to the two torque blocks.

9. The ratchet wrench of claim 8, wherein the resilient member is formed in a reversed U shape.

10. The ratchet wrench of claim 1, wherein the direction switching assembly includes a direction switching member and a pushing member, the direction switching member transversely provided with a housing, the pushing member received in the housing, wherein the pushing member includes a spring and a pushing plate, and the spring resists against a position between the pushing plate and an inner wall of the housing.
